(19) United States
(12) Patent Application Publication
(10) Pub. No.: US 2003/0236682 A1
(43) Pub. Date: Dec. 25, 2003

(54) Method and system for managing a healthcare network

(76) Inventor: Charlette L. Heyer, Milwaukee, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 10/440,853

(22) Filed: May 19, 2003

Related U.S. Application Data
(63) Continuation-in-part of application No. 09/436,043, filed on Nov. 8, 1999, now abandoned.

(51) Int. Cl. G06F 17/60

(52) U.S. Cl. 705/2

(57) ABSTRACT

A method for managing a healthcare network comprising providing a relational database for provider data, verification data, facility data, updated provided data, updated verification data, and updated facility data. Automated notification is provided when it is time to up-date the provider data, verification data, facility data, and whether it has been done. Providers, network monitors, and facilities are so notified. The data is provided through a telecommunication, internet; or other electronic session, and compared relative to one or more objective standards. The objective standards are provided via one or more electronic forms stored within the database. These electronic forms also facilitate data capture by healthcare providers and healthcare facilities, and can be pre-populated with information from the database. Mobile computer devices capture information at the facilities, which is then downloaded into the database. The method can be implemented as a computer-readable storage medium or as computer executable code stored thereon.

### CROSS-REFERENCES TO RELATED APPLICATIONS

This U.S. patent application is a continuation-in-part of, and claims priority benefit from, U.S. patent application Ser. No. 09/436,043 filed on Nov. 8, 1999.

### REFERENCE TO MICROFICHE APPENDIX

A microfiche appendix, containing computer executable code for inventive arrangements described herein, was submitted in U.S. patent application Ser. No. 09/436,043, noted above, and is again submitted herewith. The microfiche appendix is again incorporated herein by reference in its entirety, and it is considered to be a part of the disclosure of this specification.

Accordingly, it is again noted that this U.S. patent application includes a microfiche appendix having seventeen (17) jackets of microfiche with a total of eight hundred and ninety-four (894) frames. This microfiche appendix includes computer executable code for preferred embodiments hereof. In alternative embodiments hereof, however, the inventive arrangements may also be likewise implemented.

In accordance with the foregoing, a part of the disclosure of this specification contains material that is subject to U.S. copyright protection. However, the copyright owner has no objection to the facsimile reproduction by anyone of either the patent document or this disclosure material, as both appear in the Patent and Trademark Office records, but otherwise reserves all copyright interests and rights whatsoever.

### BACKGROUND OF THE INVENTION

1. Field of the Invention

The present invention relates generally to managing healthcare networks, and more specifically, to improved methods and systems for managing provider data, verification data, and facility data related thereto.

2. Discussion of Related Art

Common healthcare networks consist of thousands of healthcare providers providing medical care for tens of thousands patients. Each of the providers may, in turn, utilize multiple healthcare facilities, including multiple hospitals, multiple provider offices, and multiple free-standing facilities—such as, for example, multiple imaging, therapy, and laboratory sites.

To adequately manage a healthcare network, one or more network monitors must extensively review the qualifications of the network providers and network facilities. This process must generally be completed in accordance with rigid, objective, national standards, including, for example, standards set by the National Committee for Quality Assurance (“NCQA”) and Joint Commission on Accreditation of Healthcare Organizations (“JCAHO”).

In order to meet NCQA, JCAHO, and other standards, healthcare networks keep detailed records about every provider and every facility within their network. To this end, many, if not all, healthcare networks commonly perform periodic facility visits and perform extensive medical record reviews thereat. Significant information is collected and recorded at these facility visits. Thus, the typical healthcare network manages and maintains this information in provider and facility records. The healthcare network often then uses this information to generate detailed reports about its providers and facilities. Moreover, as healthcare networks continue to merge and grow, the pragmatic data management problems created thereby will continue to escalate.

Healthcare networks also use this detailed information about their providers and facilities to serve and assist their patients. For example, the information can be used to direct patients to appropriate providers and facilities within the network.

Preferably, but heretofore unrealized, it would be beneficial to make this kind of information available from a single data source, thereby enabling the healthcare network to have continuous, reliable access thereto in order to, for example, perform routine tasks, such as responding to daily telephonic inquires. It is hereby recognized that it would be further beneficial to centralize provider data, verification data, and facility data into a central database, whereby healthcare networks can perform multiple tasks with increased effectiveness and efficiency. With such a centralized database for managing provider data, verification data, and facility data, smaller healthcare networks will be able to effectively compete with larger healthcare networks.

Several of the following U.S. patents attempted partial solutions to some of the foregoing concerns, some of which were, occasionally, and in part, satisfactory for the limited purposes for which they were intended. The disclosures of each of the following U.S. patents are hereby incorporated by reference, in their entireties, into the present application for purposes including, but not limited to, indicating the background of the present invention and illustrating the state of the art.

U.S. Pat. No. 4,878,175, issued on Oct. 31, 1989 to Norden-Paul, automates a hospital recording keeping system. More specifically, it recognizes that as a patient transfers between various sections of a hospital, each different hospital section may record common, redundant information about a patient. Thus, Norden-Paul discloses creating a single form for a hospital patient, which is then accessible throughout the various sections of the hospital. So, for example, if a cardiologist records a patient's blood pressure in a cardiology section, that information is made available to the immunology section of the hospital. Since different sections of the hospital have different medical requirements, each can customize the form for their particular use. Accordingly, various parameters can be added to, and deleted from, patient-specific charts to suit the needs of a particular hospital or section thereof. In sum, Norden-Paul replaces an internal manual hospital record charting system with a centralized, bed-side accessible version thereof.

U.S. Pat. No. 5,070,452, issued on Dec. 3, 1991 to Doyle, Jr., et al., discloses a computerized insurance claim processing system that links a provider's office and insurance company by means of a central administration computer. The system provides up-to-date information to the provider as to the insurance coverage of a patient. The system also allows real-time modification of the information, including the identity of patients covered and types of available insurance benefits.

U.S. Pat. No. 5,301,105, issued on Apr. 5, 1994 to Cummings, Jr., discloses an integrated healthcare system that includes integrated interconnection and interaction of the patient, healthcare provider, bank or other financial institution, insurance company, utilization reviewer, and employer, so as to include each of these essential participants within a single system. This is beneficial so that patients have complete and comprehensive pre-treatment, treatment, and post-treatment healthcare, as well as pre-determined financial support therefor.

U.S. Pat. No. 5,557,514, issued on Sep. 17, 1996 to Seare, et al., discloses a method and system for analyzing historical medical provider billings to statistically establish a normative utilization profile. Comparison of a medical provider's utilization profile with a normative profile is enabled. Based on historical treatment patterns and a fee schedule, an accurate model of the cost of a specific medical episode can be created. Various treatment patterns for a particular diagnosis can be compared by treatment costs and patient outcomes to determine a cost-effective treatment approach. This patent also discloses identifying medical providers who provide treatment that does not fall within statistically established treatment patterns or profiles.

U.S. Pat. No. 5,706,441, issued on Jan. 6, 1998 to Lockwood, discloses a method and apparatus for objectively assessing the complexity of healthcare services delivered by each healthcare provider within a group of healthcare providers to patients serviced by the group of healthcare providers. In-patient data records representative of in-patient healthcare services performed for patients are stored in a database. Out-patient data records representative of outpatient healthcare services performed for patients are also stored in a database. Case load complexity levels are determined for healthcare providers within the group of healthcare providers from severity of sickness scores for each patient. Each caseload complexity level represents a patient caseload serviced by a particular healthcare provider within the group of healthcare providers.

U.S. Pat. No. 5,778,345, issued on Jul. 7, 1998 to McCartney, discloses a method and system for evaluating healthcare provider performance, forecasting healthcare resource consumption on a macroeconomic scale, and optimizing the allocation of healthcare resources. The method tracks patient addresses at discharge; establishes a referral population for a healthcare provider based upon market share; calculates occurrence rates of medical services demanded for a referral population; applies future population growth factors to the referral population; applies the occurrence rates to the projected referral population to forecast the consumption of health resources; and then allocates healthcare resources in accordance with that forecast. In addition, the invention also computes caseload volume, i.e., medical services demanded which have gone to another healthcare provider, but could have been handled by the subject healthcare provider. Finally, the invention provides for a method for efficiently allocating health resources among neighboring healthcare providers, based on either current or forecasted medical service demand data.

U.S. Pat. No. 5,890,129, issued on Mar. 30, 1999 to Spurgeon, discloses an information-exchange system for controlling the exchange of business and clinical information between an insurer and multiple healthcare providers. The system includes an information-exchange computer that is connected over a local area network to an insurer computer using a proprietary database, and over the Internet to healthcare provider computers using open database-compliant databases. The information-exchange computer receives subscriber insurance data from the insurance computer, translates the insurance data into an exchange database, and pushes the subscriber insurance data out over the Internet to the computer operated by the healthcare provider assigned to each subscriber. The information-exchange system stores the data in a provider database. The information-exchange system also provides for the preparation, submission, processing, and payment of claims over the local area network and with push technology over the Internet. In addition, prior authorization requests may be initiated in the provider computers and exchanged over the information-exchange system for review by the insurer computer. Processed reviews are transmitted back to the provider computer and to a specialist computer, if required, using push technology over the Internet.

U.S. Pat. No. 6,035,276, issued on Mar. 7, 2000 to Newman, discloses a medical practitioner credentialing system containing a database which contains i) physician credentialing profiles, and ii) specific application formats corresponding to various healthcare provider organizations. After a physician creates a credentialing profile, the physician can use that data to fill-out a particular application, the requirements of which are stored within the database. In other words, after the physician creates the credentialing profile, the physician can thereafter specify which application formats are desired, for which the system will then fill out part of the application with information from the physician's credentialing profile within the database. As a result, multiple application formats can then be completed and transmitted to multiple provider organizations.

Heretofore, many prior art solutions have not been implemented without incurring various disadvantages. For example, many prior art solutions are prohibitively expensive and provide limited functionality. Whereas providing healthcare is a competitive business, a preferred solution will be cost effective.

Thus, a need exists for a fast, efficient, cost-effective, state-of-the-art, electronic, computerized, database management tool that will allow nearly any healthcare network to effectively and efficiently manage healthcare providers and healthcare facilities. Accordingly, a method and system that can ease database management problems for healthcare networks, and thereby successfully implement quality and effective healthcare for patients, remains desirable.

### SUMMARY OF THE INVENTION

By way of general summary, inventive arrangements are directed to improved methods and systems for managing a healthcare network. By way of specific summary, inventive arrangements are directed to improved methods and systems for managing provider data, verification data, and facility data for a healthcare network. By way of more specific summary, inventive arrangements are directed to improved methods and systems for providing a relational database for provider data, verification data, and facility data, then storing provider data within the database, updating the provider data to provide updated provided data within the database, storing verification data within the database, updating the verification data to provide updated verification data within the database, storing facility data within the database, and updating the facility data to provide updated facility data within the database. The inventive methods can also be implemented on a computer-readable storage medium containing computer executable code, and conversely, as computer executable code stored on a computer-readable medium.

These and other facets of the inventive arrangements will be better appreciated and understood when considered in conjunction with the following description and the accompanying drawings. It should be understood, however, that the following description, while indicating preferred embodiments of the inventive arrangements, is given by way of illustration and not of limitation. Thus, many changes and modifications may be made within the scope of the inventive arrangements without departing from the spirit thereof, and the inventive arrangements is inclusive thereof.

### BRIEF DESCRIPTION OF THE SEVERAL VIEWS OF THE DRAWINGS

A clear conception of the advantages and features constituting the inventive arrangements, and of the construction and operation of typical mechanisms provided herewith, will become more readily apparent by referring to the exemplary, and therefore non-limiting, embodiments illustrated in the drawings, which form a part of this specification, wherein like reference numerals generally designate the same elements in the several views, and in which:

FIG. 1 is a schematic view of part of a representative healthcare network in which preferred embodiments of inventive arrangements may be practiced;

FIG. 2 is a computer system by which preferred embodiments of inventive arrangements may be practiced;

FIG. 3 is a schematic view of a relational database of a data application program of the present invention; and

FIG. 4 is a flow diagram illustrating generalized methods of the present invention.

### DETAILED DESCRIPTION OF PREFERRED EMBODIMENTS

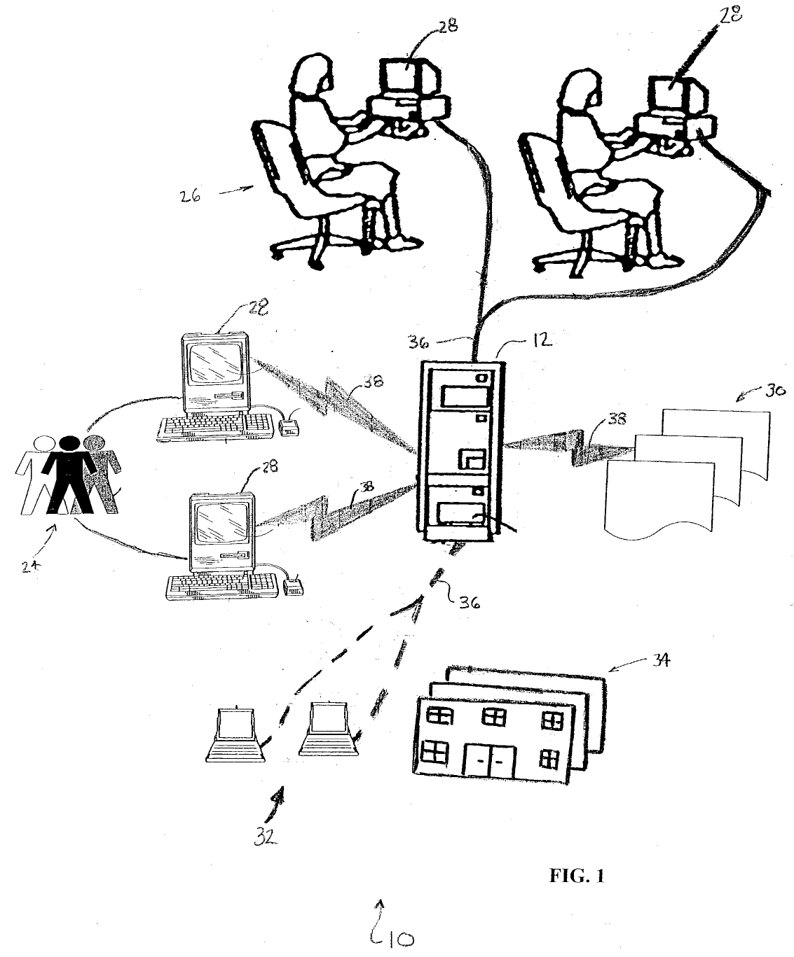

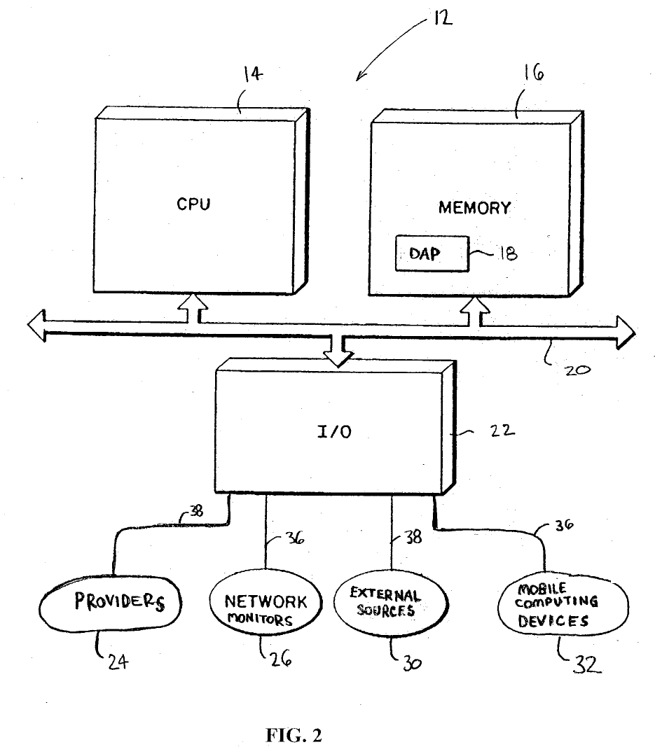

A schematic view of part of a representative healthcare network 10 is shown in FIG. 1, in which preferred embodiments of inventive arrangements may be practiced. Referring more specifically to FIG. 2, the inventive arrangements are preferably implemented on a computer system 12 comprising a central processing unit (“CPU”) 14 and one or more memory devices 16. Typically, the one or more memory devices 16 comprise volatile memory (not shown), such as random access memory (“RAM”), and non-volatile memory (not shown), such as a hard disk drive or other fixed-storage memory device.

The non-volatile memory, which may include read only memory (“ROM”), commonly stores therein an operating system (not shown) and one or more application programs, such as the database application program (“DAP”) 18 of the present invention. Alternatively, one or more application programs, including the DAP 18 of the present invention, may be stored in a removable memory device, such as, for example, a floppy disk, an optical disk for use with a CD-ROM, and so forth. In any event, both the CPU 14 and the one or more memory devices 16 can be any suitable devices known to those skilled in the art, wherein, for example, the operating system is conventionally loaded from the non-volatile memory into the volatile memory during bootstrapping of the computer system 12, and then executed. Subsequently, the operating system then conventionally loads the DAP 18 from the non-volatile memory into the volatile memory for execution. Upon the loading thereof, the CPU 14 then executes the DAP 18. More specifically, the CPU 14 executes one or more programmed code sections that comprise the DAP 18 in order to perform various operations, including the database operations of the inventive arrangements. Each programmed code section thus includes instructions that are executed by the CPU 14. As such, the inventive arrangements of the present DAP 18 are carried out.

Alternatively, one skilled in the art will recognize that the inventive arrangements can also be realized in hardware, software, firmware, or various combinations thereof. A representative visualization tool according to the inventive arrangements can be realized in a centralized fashion over one computer system 12, or, alternatively, in a distributed fashion in which multiple elements and components are spread over multiple, interconnected computer systems 12. Moreover, any kind of computer system 12, or other apparatus, adapted for carrying out the inventive methods described herein is suited. A typical combination of hardware and software, for example, could be a general purpose computer system 12 with a computer program that, upon loading and execution, controls the computer system 12 such that the inventive methods described herein are carried out. The present invention can also be embedded in a computer program product comprising the features of an enabling implementation of the inventive methods described herein, and which, upon being loaded and executed by the computer system 12, thus carries out the inventive methods.

In the context of this description, application programs, computer programs, and the like, include any expression, in any language, code, or notation, of a set of instructions intended to cause a computer system 12, or the like, having an information processing capability, to perform a particular function either i) directly, or ii) after either or both of the following occur: a) conversion to another language, code, or notation; or b) reproduction in a different material form.

In the microfiche embodiment, for example, the DAP 18 of the present invention was written in a Clarion programming language, version 5.0, readily available from TopSpeed Corporation of Pompano Beach, Fla. at the time of the invention—and presently available from SoftVelocity, Inc., also of Pompano Beach, Fla. Regardless, the DAP 18 can be written in any comparable relational database programming language providing the same basic functionality of the Clarion programming language, and, in the preferred embodiment, was written to run on a network of microcomputers running Microsoft Windows, readily available from Microsoft Corporation of Redmond, Wash.

In any event, in operation of the preferred embodiment shown in FIG. 2, the CPU 14 and one or more memory devices 16 communicate through a conventional bus 20, which additionally interfaces with one or more input/output (“I/O”) devices 22 connected thereto. The I/O devices 22 allow various parties to communicate with the DAP 18 of the computer system 12, including, for example, one or more providers 24 and one or more network monitors 26. More specifically, the one or more providers 24 preferably communicate with the DAP 18 of the computer system 12 through a personal computer 28, as do the one or more network monitors 26. The I/O devices 22 also allow one or more external sources 30 to communicate with the DAP 18 of the computer system 12, as well as one or more mobile computing devices 32, such as, for example, a laptop computer, handheld computing device, or the like. As will be elaborated upon below, the one or more mobile computing devices 32 enable data capture at one or more facilities 34 of the healthcare network 10.

In a preferred embodiment, the one or more network monitors 26 interact with the computer system 12 through a dedicated connection 36, as do the one or more mobile computing devices 32 when they are attached to, and therefore communicating with, the computer system 12. Likewise, the one or more providers 24 preferably interact with the computer system 12 through a virtual connection 38, as do the one or more external sources 30. The virtual connection 38 can be, for example, provided through a dial-up, cable modem, or Internet session, or otherwise, in which case the computer system 12 maintains, for example, a web-server module (not shown) and home-page, as known in the art, for providing such services. However, the inventive arrangements are not limited in this regard. For example, any of the one or more providers 24, one or more network monitors 26, one or more external sources 30, and one or more mobile computing devices 32 may interact with the computer system 12 through a dedicated connection 36, virtual connection 38, or otherwise, including, for representative purposes, interaction by other known techniques such as floppy disk data transfers, wireless transfers, and otherwise. Other electronic means—as opposed to manual means of data communication and data entry—are also hereby contemplated.

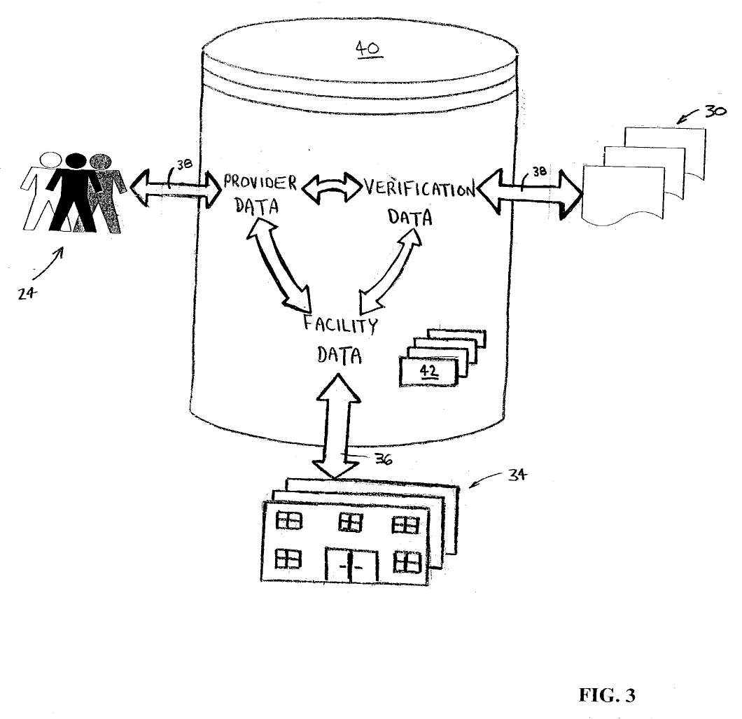

Referring now to FIG. 3, the DAP 18 of the present invention includes a relational database 40, which structures data in the form of related tables, allows data to be viewed in multiple ways, allows a single database to be spread out over multiple tables, and allows data to be extracted without navigating through a flat database hierarchy. More specifically, the relational database 40 stores therein provider data, verification data, and facility data. Moreover, the provider data can be updated to provide updated provider data within the relational database 40, the verification data can be updated to provide updated verification data within the relational database 40, and the facility data can be updated to provide updated facility data within the relational database 40. The provider data, verification data, facility data, updated provider data, updated verification data, and updated facility data are interrelated within the relational database 40. More specifically, the relational database 40 ties together data from at least three sources, including: i) medical providers 24, such as doctors, physicians, surgeons, nurses, and the like; ii) external sources 30, such as state provider licensing agencies, and the like; and iii) medical facilities 34, such as hospitals, provider offices, and free standing centers—including, for example, imaging centers, therapy centers, laboratory sites, and the like.

The relational database 40 may also contain information about patients of the healthcare network 10, such as patients' names, identification numbers, dates of visits to one of the one or more providers 24, and the like. Moreover, the relational database 40 also preferably contains one or more electronic forms 42, as will be elaborated upon below, for use during a provider update session, verification update session, facility update session, and otherwise. The electronic forms 42 also contain one or more objective standards for the provider data, verification data, facility data, updated provider data, updated verification data, and updated facility data, as well forms for various letters, and the like, for communicating to the one or more providers 24, the one or more external sources 30, and the one or more facilities 34. By storing these electronic forms 42 within the electronic database 40, changes thereto are easy to implement, and ensures the DAP 18 uses updated versions thereof. Periodic updates to the electronic forms 42 are easily maintained by the one or more network monitors 26.

### PROVIDER DATA

Preferably, the one or more providers 24 provide provider data when they originally affiliate with the healthcare network 10. More specifically, representative provider data includes detailed background information about the one or more providers 24, whereby the provider data is preferably stored in one or more provider files within the relational database 40, including, for example, information such as assistantships, back-ups, contact information, contracts, deficiencies, documents, domestic educational histories, enrollments, fellowships, foreign educational histories, gender, hospital admittance privileges, insurance policies, internships, languages, legal claims, office locations, professional associations, references, residences, sanctions, specialties, state licenses, teaching experiences, work histories, and so forth for each of the one or more providers 24. Such provider data can be conventionally prompted to the one or more providers 24 for entry thereof into the relational database 40. For example, in a preferred embodiment, the one or more providers 24, or their agents, may enter this provider data through an Internet session based on a client-server model between the personal computer 28 and computer system 12. Regardless, a conventionally user-friendly data entry interface is preferred, and one or more electronic forms 42 from the relational database 40 can be used for this purpose. Thus, the inventive arrangements preferably replace manual entry of provider data with automated entry thereof. In any event, the provider data for the one or more providers 24 is thereby entered into, received by, and stored within the relational database 40.

Periodically, the one or more providers 24 must re-certify their credentials with the healthcare network 10. This process, known as recredentialling, is commonly required every 1-2 years for each of the one or more providers 12 within the healthcare network 10. However, as many pieces of the provider data may expire at different times of the year for each of the one or more providers 24, it becomes difficult, if not impossible, to manually manage overseeing this recredentialling process even for a small group of one or more providers 24. Thus, the DAP 18, in conjunction with the relational database 40, is programmed to provide automated notification when at least some portion of the provider data needs to be updated. This automated notification can be provided to the effected provider of the one or more providers 24, or to one or more of the one or more network monitors 26, or to both. As to the effected provider of the one or more providers 24, automated notification by the DAP 18 can include automatically sending a hardcopy letter or e-mail message thereto, or otherwise. As to the one or more network monitors 26, automated notification by the DAP 18 can include displaying a message on the personal computer 28 through the dedicated connection 36, or otherwise. The DAP 18 can also provide additional reminder notices to both parties as necessary to prompt for the completion of this information.

In a representative automated notification implementation to one or more of the providers 24, for example, an access identifier and password can be automatically communicated to the effected provider, whereby that provider can be provided with directions for updating their effected provider data. Thus, secured access to, as well as directions thereregarding, can be provided to the effected provider for accessing the DAP 18 to update the provider data during a provider update session. During the provider update session, the effected provider can be prompted to update their effected provider data using one or more of the one or more electronic forms 42 from the relational database 40. For example, the effected provider can be prompted to correct any erroneous or expiring provider data with the relational database 40.

Furthermore, due to the report generating capabilities of the DAP 18 operating in conjunction with the relational database 40, reports can also be provided to the one or more network monitors 26 indicating, for example, current recredentialling activities in process, recredentialling activities in process for over a specified number of days, responsive requests for updated provider data, unresponsive requests for updated provider data, monthly—or otherwise—re-credentialing data, and so forth. Accordingly, any of the data fields of the relational database 40 can be used in this fashion by the one or more network monitors 26.

During a common provider update session, it will, of course, be recognized that much of the provider data may not need to be updated. For example, the provider's name or medical school history are not likely to have changed since the provider originally affiliated with the healthcare network 10. Thus, providing the one or more electronic forms 42 to the effected provider preferably pre-completes at least a portion of at least one of the one or more electronic forms 42 with previous provider data from the relational database 40, whereby only specified information is prompted for change. Thus, once the updated provider data is gathered according to the one or more electronic forms 42, it can be uploaded for storage into the relational database 40, after which the provider update session ends. Thus, updating the provider data to provide updated provider data within the relational database 40 preferably includes providing one or more electronic forms 42 to the provider for use during the provider update session, after which the updated provider data is uploaded into the relational database 40 for storage thereof.

In a preferred embodiment, the one or more providers 24 provide the provider data and updated provided data through a telecommunication, internet, or other electronic session, as previously elaborated upon. However, the inventive arrangements are not limited in this regard. For example, if one or more of the providers 24 are already affiliated with another healthcare network, their provider data, and updated provider data, if any, can be conventionally uploaded into the relational database 40 of the DAP 18 of the present invention by known techniques. Similarly, if a provider has captured provider data, or updated provider data, if any, onto a floppy disk, or the like, that medium can be conventionally provided to the one or more network monitors 26 for incorporation and up-loading into the relational database 40 by known techniques.

As previously alluded to, effectively managing the recredentialling process for even a small group of one or more providers 24 can be challenging. Thus, it may be insufficient to only provide automated notification to the one or more providers 24, or to the one or more network monitors 26, as to when at least a portion of the provider data needs to be updated. Rather, in a preferred embodiment, the computer system 12 also provides automated notification regarding whether or not at least a portion of the provider data has been successfully updated. For example, the effected provider of the one or more providers 24, and well as one or more of the one or more network monitors 26, may also receive periodic reminders of the need to update the provider data, until a time at which the updated provider data has been successfully provided. Thus, automated notification, to either or both of at least one of the one or more providers 24 and at least one of the one or more network monitors 26, is preferably provided to indicate whether or not at least a portion of the provider data has been updated. After the updated provider data has been provided through the provider update session, or otherwise, the automated notification then ends.

### VERIFICATION DATA

Certain portions of the provider data and updated provider data need to confirmed with one or more external sources 30 that are independent from the one or more providers 24. This process, commonly called credential verification, occurs when the healthcare network 10 verifies the accuracy of certain portions of the provider data, and updated provider data, submitted by the one or more providers 24 or their agents. To complete a typical credentialing verification process, it is commonly necessary to access several different external sources 30 to verify asserted information. For example, the healthcare network 10 requires verifying the medical education of the one or more providers 24 from applicable universities, the medical training of the one or more providers 24 from applicable hospitals, hospital admitting privileges of the one or more providers 24 from applicable hospitals, medical licenses of the one or more providers 24 from applicable state licensing boards, and so forth. In any event, the one or more external sources 30 typically provide verification data when one or more of the providers 24 originally affiliate with the healthcare network 10. In any event, once the verification data is received from the one or more external sources 30, it is stored within the relational database 40 by the DAP 18.

Such verification data can be conventionally prompted to the one or more external sources 30 for entry thereof into the relational database 40. For example, in a preferred embodiment, the one or more external sources 30 may enter this verification data through an Internet session based on a client-server model between the one or more external sources 30 and the computer system 12. Regardless, a conventionally user-friendly data entry interface is preferred, and one or more electronic forms 42 from the relational database 40 can be used for this purpose. Thus, the inventive arrangements preferably replace manual entry of verification data with automated entry thereof. In any event, the verification data for the one or more providers 24 is thereby entered into, received by, and stored within the relational database 40.

Periodically, the one or more external sources 30 must re-certify their verification data with the healthcare network 10. This process commonly occurs as the one or more providers 24 recredential their provider data to provide updated provider data to the DAP 18. Thus, the DAP 18, in conjunction with the relational database 40, is preferably programmed to provide automated notification when at least some portion of the verification data needs to be updated. This automated notification can be provided to the effected external source of the one or more external sources 30, or to one or more of the one or more network monitors 26, or to both. In any event, verification data can be updated during a verification update session.

During the verification update session, the effected external source can be prompted to update their effected verification data using one or more of the one or more electronic forms 42 from the relational database 40. For example, the effected external source can be prompted to correct any erroneous or expiring verification data with the relational database 40.

During a common verification update session, it will, of course, be recognized that much of the verification data may not need to be updated. Thus, providing the one or more electronic forms 42 to the effected external source preferably pre-completes at least a portion of at least one of the one or more electronic forms 42 with previous verification data from the relational database 40, whereby only specified information is prompted for change. Thus, once the updated verification data is gathered according to the one or more electronic forms 42, it can be uploaded for storage into the relational database 40, after which the verification update session ends. Thus, updating the verification data to provide updated verification data within the relational database 40 preferably includes providing one or more electronic forms 42 to the external source for use during the verification update session, after which the updated verification data is uploaded into the relational database 40 for storage thereof.

As previously alluded to, effectively managing the recredentialling process for even a small group of one or more providers 24 can be challenging. Thus, it may be insufficient to only provide automated notification to the one or more external sources 30, or to the one or more network monitors 26, as to when at least a portion of the verification data needs to be updated. Rather, in a preferred embodiment, the computer system 12 also provides automated notification regarding whether or not at least a portion of the verification data has been successfully updated. For example, the effected external source of the one or more external sources 24, and well as one or more of the one or more network monitors 26, may also receive periodic reminders of the need to update the verification data, until a time at which the updated verification data has been successfully provided. Thus, automated notification, to either or both of at least one of the one or more externals sources 30 and at least one of the one or more network monitors 26, is preferably provided to indicate whether or not at least a portion of the verification data has been updated. After the updated verification data has been provided through the verification update session, or otherwise, the automated notification then ends.

### FACILITY DATA

As previously mentioned, the healthcare network 10 comprises one or more facilities 34, such as hospitals, provider offices, and free standing centers—including, for example, imaging centers, therapy centers, laboratory sites, and the like. Periodically, various ones of the one or more facilities 34, especially the provider offices, must be visited to determine compliance with federal, state, and local requirements for the safe provision of medical care. Also during a visit to the one or more facilities 34, patient medical records are commonly reviewed, again to determine compliance with federal, state, and local requirements for patient confidentiality and the like. Record reviews are used to determine, for example, whether the one or more providers 24 of the one or more facilities 34 follow acceptable standards for delivering medical care, properly document medical treatments, perform appropriate follow-up for additional and continued care, and so forth. Conventionally, facility visits and record reviews involved lengthy, hand-written, manual processes, with pages of questions, answers, and documentation. However, the DAP 18 of the present inventive arrangements provides mobile computing devices 32 that facilities data capture at the one or more facilities 34 of the healthcare network 10. For example, one or more electronic forms 42 from the relational database 40 can be downloaded onto the mobile computing device 32 prior to visiting one or more of the facilities 34, for use thereat.

Preferably, facility data is provided when the one or more facilities 34 originally affiliate with the healthcare network 10. More specifically, representative facility data includes detailed background information about the one or more facilities 34, whereby the facility data is preferably stored in one or more facility files within the relational database 24, including, for example, information such as whether sharps containers are properly used for disposing of hypodermic needles, whether restrooms are handicap accessible, whether pharmaceutical drugs are locked in appropriate cabinets, whether patient medical records are securely stored away from access by non-authorized personnel, and so forth. Other facility data that can be collected includes information about the exterior of the one or more facilities 34, the interiors thereof, including the office spaces of the one or more providers 24, general safety information, appointment availability, waiting time data, patient care information, patient feedback information, emergency care information, equipment at the facility, medications available at the one or more facilities 34, information about various licenses maintained thereby, OSHA information, policy and procedure questions, and the like. Such facility data is preferably prompted to network personnel visiting the one or more facilities 34, such as nurses (not shown) or the like, for entry thereof into the mobile computing device 32 according to the one or more electronic forms 42 from the relational database 40. Thus, a conventionally user-friendly data entry interface is preferred, and one or more electronic forms 42 from the relational database 40 can be used for this purpose. Thus, the inventive arrangements preferably replace manual entry of facility data with automated entry thereof. Moreover, in one embodiment, objective, as opposed to subjective, responses are preferably prompted to the network personnel visiting the one or more facilities 34 for entry thereof into the mobile computing device 32. For example, the network personnel visiting the one or more facilities 34 can be prompted to respond Yes, No, or Not Applicable, to questions such as whether entries on a medical record are dated, legible, and identify the author, whether a list is maintained to identify significant illnesses and medical conditions, whether a list is maintained to identify medications a patient is currently taking, and so forth. In this fashion, objective responses standardize network personnel responses for incorporation into the relational database 40. Accordingly, the one or more electronic forms 42 for enabling facility data capture can be programmed to suit the needs of the healthcare network 10—as can the one or more electronic forms 42 for enabling provider data capture, verification data capture, updated provider data capture, updated verification data capture, and so forth. In any event, the facility data for the one or more facilities 34 is thereby entered into, received by, and stored onto the one or more mobile computing devices 32.

While information from the database 40 can be used to used to pre-populate one or more parts of the one or more electronic forms 42 to be used during the facility visit, information from the relational database 40 can also be used to pre-populate one or more parts of the one or more electronic forms 42 to be used during the record review. For example, a patient's name, identification number, dates of visits to one of the one or more providers 24, and the like, can be downloaded from the relational database 40 onto at least a part of the one or more electronic forms 42 for use while reviewing the patients medical records at the one or more facilities 34. Thus, various patient records can be identified for review prior to the facility visit, adding data capture thereat.

Periodically, the one or more facilities 24 must re-certify their facility with the healthcare network 10. Thus, the DAP 18, in conjunction with the relational database 40, is preferably programmed to provide automated notification when at least some portion of the facility data needs to be updated. This automated notification is preferably provided to one or more of the one or more network monitors 26. As explained, during the facility update session, the effected facility can be prompted to update their effected facility data using one or more of the one or more electronic forms 42 from the relational database 40, which have been temporarily downloaded from the relational database onto the one or more mobile computer devices 32.

During a common facility update session, it will, of course, be recognized that much of the facility data may not need to be updated. Thus, providing the one or more electronic forms 42 to the effected facility preferably pre-completes at least a portion of at least one of the one or more electronic forms 42 with previous facility data from the relational database 40, whereby only specified information is prompted for change. Thus, once the updated facility data is gathered according to the one or more electronic forms 42 and stored onto the one or more mobile computing devices 32, it is later uploaded from the one or more mobile computing devices 32 into the relational database 40.

Effectively managing facility oversight for even a small group of one or more facilities 34 can be challenging. Thus, it may be insufficient to only provide automated notification as to when at least a portion of the facility data needs to be updated. Rather, in a preferred embodiment, the computer system 12 also provides automated notification regarding whether or not at least a portion of the facility data has been successfully updated. For example, the effected facility of the one or more facilities 34, and well as one or more of the one or more network monitors 26, may also receive periodic reminders of the need to update the facility data, until a time at which the updated facility data has been successfully provided. Thus, automated notification, to either or both of at least one of the one or more facilities 34 and at least one of the one or more network monitors 26, is preferably provided to indicate whether or not at least a portion of the facility data has been updated. After the updated facility data has been provided through the facility update session, or otherwise, the automated notification then ends.

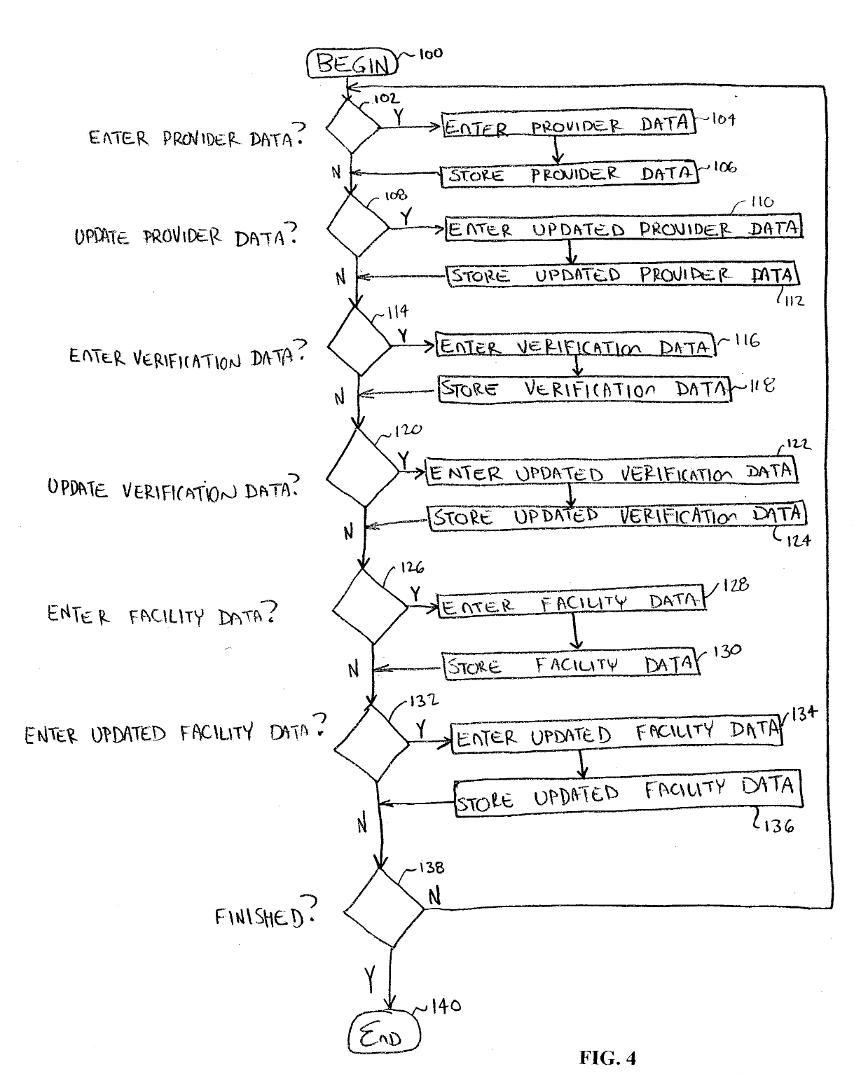

Referring now to FIG. 4, generalized methods of the inventive arrangements are illustrated, for which the CPU 14 of FIG. 2 begins executing one or more programmed code sections beginning at step 100, followed by step 102, in which it is determined whether provider data will be entered into the relational database 40.

If provider data will be entered in step 102, then step 104 is executed, in which the provider data is entered into the computer system 12, which is then followed by step 106, in which the provider data is then stored within the relational database according to the DAP 18. If, on the other hand, provider data will not be entered in step 102, or following step 106, then step 108 is executed, in which it is determined whether the provider data will be updated.

If the provider data will be updated in step 108, then step 110 is executed, in which the updated provider data is entered into the computer system 12, which is then followed by step 112, in which the updated provider data is then stored within the relational database according to the DAP 18. If, on the other hand, provider data will not be updated in step 108, or following step 112, then step 114 is executed, in which it is determined whether verification data will be entered.

If verification data will be entered in step 114, then step 116 is executed, in which the verification data is entered into the computer system 12, which is then followed by step 118, in which the verification data is then stored within the relational database according to the DAP 18. If, on the other hand, verification data will not be entered in step 114, or following step 118, then step 120 is executed, in which it is determined whether the verification data will be updated.

If the verification data will be updated in step 120, then step 122 is executed, in which the updated verification data is entered into the computer system 12, which is then followed by step 124, in which the updated verification data is then stored within the relational database according to the DAP 18. If, on the other hand, verification data will not be updated in step 120, or following step 124, then step 126 is executed, in which it is determined whether facility data will be entered.

If facility data will be entered in step 126, then step 128 is executed, in which the facility data is entered into the computer system 12, which is then followed by step 130, in which the facility data is then stored within the relational database according to the DAP 18. If, on the other hand, facility data will not be entered in step 126, or following step 130, then step 132 is executed, in which it is determined whether the facility data will be updated.

If the facility data will be updated in step 132, then step 134 is executed, in which the updated facility data is entered into the computer system 12, which is then followed by step 136, in which the updated facility data is then stored within the relational database according to the DAP 18. If, on the other hand, facility data will not be updated in step 132, or following step 136, then step 138 is executed, in which it is determined whether additional provider data, updated provider data, verification data, updated verification data, facility data, or updated facility data will be entered and stored within the relational database 40 according to the DAP 18.

If additional provider data, updated provider data, verification data, updated verification data, facility data, or updated facility data will be entered and stored within the relational database 40 according to the DAP 18, then control returns to step 102, in which it is again determined whether provider data will be entered into the relational database 40. Thereafter, control flows from step 102 as previously described. If, on the other hand, additional provider data, updated provider data, verification data, updated verification data, facility data, or updated facility data will not be entered and stored within the relational database 40 according to the DAP 18, then step 140 is executed, in which the CPU 14 of FIG. 2 stops executing programmed code sections, and the generalized methods end.

Referring again generally, in one preferred embodiment, once the provider data, verification data, facility data, updated provider data, updated verification data, and updated facility data have been received by and stored within the relational database 40, each thereof is compared to one or more objective, national standards therefore. For example, it can be determined whether each thereof exceeds objective, national standards therefore. In another preferred embodiment, each of the provider data, verification data, facility data, updated provider data, updated verification data, and updated facility data can be scored relative to one or more objective, national standards therefore. All of the foregoing are calculated by the DAP 18 of the present invention by known techniques. In another preferred embodiment, the DAP 18 provides automated notification to one or more parties based on the results of the foregoing scoring. In yet another preferred embodiment, the scoring of the provider data, verification data, facility data, updated provider data, updated verification data, and updated facility data can be determined on a pass-fail basis relative to objective, national standards therefore, for which the DAP 18 again provides automated notification to one or more parties based on the results of the foregoing scoring. Automated notification, for example, can be provided to the one or more providers 24 or to the one or more network monitors 26.

In another preferred embodiment, once the provider data, verification data, facility data, updated provider data, updated verification data, and updated facility data have been received by and stored within the relational database 40, each thereof can be accessed in response to a request thereregarding. Thus, the one more network monitors 26 can quickly and efficiently identify appropriate providers based on simple or complex patient needs. For example, using the relational database 40 within the DAP 18 of the present invention allows the one more network monitors 26 to identify a podiatrist who speaks Russian and is located in a specific zip code. As another representative example, the one or more network monitors 26 can identify a provider who is a professor at a particular university, teaches clinics, is an internist who participates as a provider for patients in a specific health plan, and is accepting new patients. This information can be identified due to the interrelationship of the data within the relational database 40.

In yet another preferred embodiment, once the provider data, verification data, facility data, updated provider data, updated verification data, and updated facility data have been received by and stored within the relational database 40, one or more reports can be generated relative thereto in response to a request thereregarding. For example, a report identifying provider specialties or an alphabetic listing of all providers may be provided. Similarly, a report identifying providers with multiple specialties may be provided, as may a report identifying which of the one or more providers 24 have access to which of the one or more facilities 34, and so forth, consistent with inquiries made of the data in the relational database 40. Preferably, the use of an Open Data Base Connectivity (“ODBC”) software driver (not shown) allows the one or more network monitors 26 to access the various fields of the relational database 40 using third party report writing software programs, such as, for example, Crystal Reports available from Crystal Decisions of Palo Alto, Calif.

Responding to these requests and generating reports are enabled through the use of the relational database 40 to interrelate provider data, verification data, facility data, updated provider data, updated verification data, and updated facility data. Since all of the data fields are selectable for inquiry purposes, the one or more network monitors 26 can use the DAP 18 to identify user-defined record selection. Similarly, specific target mailings to the one or more providers 24 and one or more facilities 34 is enabled through use of the data contained with the relational database 40.

The spirit of the present invention is not limited to the embodiments described above. Rather, the details and features of exemplary embodiments were disclosed as required. Without departing from the scope of this invention, other modifications should therefore remain apparent to those skilled in the art. Thus, it must be understood that this Detailed Description of the Preferred Embodiments and Figures were intended as illustrative only, and not by way of limitation.

To apprise the public of the scope of this invention, the following claims are made:

What is claimed is:

1. A method for managing a healthcare network, comprising:
(a) providing a relational database for provider data, verification data, and facility data;
(b) storing said provider data for one or more providers within said database;
(c) updating said provider data to provide updated provided data within said database;
(d) storing said verification data for said one or more providers within said database;
(e) updating said verification data to provide updated verification data within said database;
(f) storing said facility data for one or more facilities within said database; and
(g) updating said facility data to provide updated facility data within said database.

2. The method of claim 1 wherein one or more of the following is provided through a telecommunication, internet, or other electronic session: said provider data, said updated provider data, said verification data, said updated verification data, said facility data, and said updated facility data.

3. The method of claim 1 further including accessing one or more of the following within the database in response to a request thereregarding: said provider data, said updated provider data, said verification data, said updated verification data, said facility data, and said updated facility data.

4. The method of claim 1 further including generating one or more reports for one or more of the following from the database in response to a request thereregarding: said provider data, said updated provider data, said verification data, said updated verification data, said facility data, and said updated facility data.

5. The method of claim 1 further including comparing one or more of the following relative to one or more objective standards thereof: said provider data, said updated provider data, said verification data, said updated verification data, said facility data, and said updated facility data.

6. The method of claim 5 wherein at least one of said one or more objective standards is provided from said database.

7. The method of claim 1 further including exceeding one or more objective standards of one or more of the following: said provider data, said updated provider data, said verification data, said updated verification data, said facility data, and said updated facility data.

8. The method of claim 7 wherein at least one of said one or more objective standards is provided from said database.

9. The method of claim 1 further including scoring one or more of the following relative to one or more objective standards thereof: said provider data, said updated provider data, said verification data, said updated verification data, said facility data, and said updated facility data.

10. The method of claim 9 wherein at least one of said one or more objective standards is provided from said database.

11. The method of claim 9 further including automated notification to one or more parties based on said scoring.

12. The method of claim 1 further including pass-fail scoring one or more of the following relative to one or more objective standards thereof: said provider data, said updated provider data, said verification data, said updated verification data, said facility data, and said updated facility data.

13. The method of claim 12 wherein at least one of said one or more objective standards is provided from said database.

14. The method of claim 12 further including automated notification to one or more parties based on said pass-fail scoring.

15. The method of claim 1 wherein updating said provider data includes automated notification when at least a portion of said provider data needs to be updated.

16. The method of claim 1 wherein updating said provider data includes automated notification to at least one of said one or more providers when at least a portion of said provider data needs to be updated.

17. The method of claim 1 wherein updating said provider data includes automated notification to a network monitor when at least a portion of said provider data needs to be updated.

18. The method of claim 1 wherein updating said provider data includes automated notification whether at least a portion of said provider data has been updated.

19. The method of claim 1 wherein updating said provider data includes automated notification to at least one of said one or more providers whether at least a portion of said provider data has been updated.

20. The method of claim 1 wherein updating said provider data includes automated notification to a network monitor whether at least a portion of said provider data has been updated.

21. The method of claim 1 wherein updating said provider data includes:
(1) providing one or more electronic forms from said database to said one or more providers for use during a provider update session; and
(2) uploading said updated provider data into said database, said updated provider data gathered according to at least one of said one or more electronic forms during said provider update session.

22. The method of claim 21 wherein providing one or more electronic forms includes pre-completing at least a portion of at least one of said one or more electronic forms with data from said database.

23. The method of claim 1 wherein storing said provider data occurs when at least one of said one or more providers originally affiliate with a healthcare network.

24. The method of claim 1 wherein updating said provider data occurs when at least one of said one or more providers re-credential with a healthcare network.

25. The method of claim 1 wherein storing said provider data occurs when at least one of said one or more providers originally affiliate with a healthcare network and wherein updating said provider data occurs when at least one of said one or more providers re-credential with said healthcare network.

26. The method of claim 1 wherein updating said provider data includes providing an access identifier and password to at least one of said one or more providers for use during a provider update session.

27. The method of claim 26 wherein providing said access identifier and password to at least one of said one or more providers includes automated notification thereof to said one or more providers.

28. The method of claim 1 wherein updating said provider data includes prompting at least one of said one or more providers during a provider update session to correct provider data with said database.

29. The method of claim 1 wherein updating said verification data includes automated notification when at least a portion of said verification data needs to be updated.

30. The method of claim 1 wherein updating said verification data includes automated notification to at least one of one or more external sources when at least a portion of said verification data needs to be updated.

31. The method of claim 1 wherein updating said verification data includes automated notification to a network monitor when at least a portion of said verification data needs to be updated.

32. The method of claim 1 wherein updating said verification data includes automated notification whether at least a portion of said verification data has been updated.

33. The method of claim 1 wherein updating said verification data includes automated notification to at least one of one or more external sources whether at least a portion of said verification data has been updated.

34. The method of claim 1 wherein updating said verification data includes automated notification to a network monitor whether at least a portion of said verification data has been updated.

35. The method of claim 1 wherein updating said verification data includes:
(1) providing one or more electronic forms from said database to at least one of one or more external sources for use during a verification update session; and
(2) uploading said updated verification data into said database, said updated verification data gathered according to said one or more electronic forms during said verification update session.

36. The method of claim 35 wherein providing one or more electronic forms includes pre-completing at least a portion of at least one of said one or more electronic forms with data from said database.

37. The method of claim 1 wherein storing said verification data occurs when at least one of said one or more providers originally affiliate with a healthcare network.

38. The method of claim 1 wherein updating said verification data occurs when at least one of said one or more providers re-credential with a healthcare network.

39. The method of claim 1 wherein storing said verification data occurs when at least one of said one or more providers originally affiliate with a healthcare network and wherein updating said verification data occurs when at least one of said one or more providers re-credential with said healthcare network.

40. The method of claim 1 wherein updating said facility data includes automated notification when at least a portion of said facility data needs to be updated.

41. The method of claim 1 wherein updating said facility data includes automated notification to a network monitor when at least a portion of said facility data needs to be updated.

42. The method of claim 1 wherein updating said facility data includes automated notification whether at least a portion of said facility data has been updated.

43. The method of claim 1 wherein updating said facility data includes automated notification to a network monitor whether at least a portion of said facility data has been updated.

44. The method of claim 1 wherein updating said facility data includes:
(1) downloading one or more electronic forms from said database onto a mobile computing device for use during a facility update session at said one or more facilities, and
(2) storing said updated facility data onto said mobile computer device, said updated facility data gathered according to at least one of said one or more electronic forms during said facility update session.

45. The method of claim 44 wherein storing said updated facility data includes storing one or more objective responses to one or more automated requests thereregarding.

46. The method of claim 44 further including uploading said updated facility data from said mobile computing device into said database.

47. The method of claim 44 wherein downloading one or more electronic forms includes pre-completing at least a portion at least one of said one or more electronic forms with data from said database.

48. The method of claim 44 wherein at least one of said one or more electronic forms includes an electronic form selected from a group consisting of: facility review form and patient record review form.

49. The method of claim 1 wherein storing said facility data occurs when at least one of said one or more facilities originally affiliate with a healthcare network.

50. The method of claim 1 wherein updating said facility data occurs when at least one of said one or more facilities re-affiliate with a healthcare network.

51. The method of claim 1 wherein storing said facility data occurs when at least one of said one or more facilities originally affiliate with a healthcare network and wherein updating said facility data occurs when at least one of said one or more facilities re-affiliate with said healthcare network.

52. A method for managing a healthcare network, comprising:
(a) providing a relational database for provider data, verification data, and facility data;
(b) receiving provider data for one or more providers;
(c) storing said provider data within said database;
(d) receiving updated provider data for said one or more providers;
(e) storing said updated provider data within said database;
(f) receiving verification data for said one or more providers;
(g) storing said verification data within said database;
(h) receiving updated verification data for said one or more providers;
(i) storing said updated verification data within said database;
(j) receiving facility data for one or more facilities;
(k) storing said facility data within said database;
(l) receiving updated facility data for said one or more facilities; and
(m) storing said updated facility data within said database.

53. A method for managing a healthcare network, comprising:
(a) providing a relational database for provider data, verification data, and facility data;
(b) receiving provider data for one or more providers, said provider data received from said one or more providers;
(c) storing said provider data within said database;
(d) receiving updated provider data for said one or more providers, said updated provider data received from said one or more providers;
(e) storing said updated provider data within said database;
(f) receiving verification data for said one or more providers, said verification data received from one or more external sources;
(g) storing said verification data within said database;
(h) receiving updated verification data for said one or more providers, said updated verification data received from said one or more external sources;
(i) storing said updated verification data within said database;
(j) receiving facility data for one or more facilities, said facility data received from one or more facilities;
(k) storing said facility data within said database;
(l) receiving updated facility data for said one or more facilities, said updated facility data received from said one or more facilities; and
(m) storing said updated facility data within said database.

54. A method for managing a healthcare network, comprising:
(a) providing a relational database for provider data, verification data, and facility data;
(b) receiving provider data for one or more providers, said provider data received from said one or more providers according to one or more electronic forms;
(c) storing said provider data within said database;
(d) receiving updated provider data for said one or more providers, said updated provider data received from said one or more providers according to one or more electronic forms;
(e) storing said updated provider data within said database;
(f) receiving verification data for said one or more providers, said verification data received from one or more external sources according to one or more electronic forms;
(g) storing said verification data within said database;
(h) receiving updated verification data for said one or more providers, said updated verification data received from said one or more external sources according to one or more electronic forms;
(i) storing said updated verification data within said database;
(j) receiving facility data for one or more facilities, said facility data received from one or more facilities according to one or more electronic forms;
(k) storing said facility data within said database;
(l) receiving updated facility data for said one or more facilities, said updated facility data received from said one or more facilities according to one or more electronic forms; and
(m) storing said updated facility data within said database.

55. A computer-readable storage medium containing computer executable code for instructing a computer system to operate as follows:
(a) provide a relational database for provider data, verification data, and facility data;
(b) store said provider data for one or more providers within said database;
(c) update said provider data to provide updated provided data within said database;
(d) store said verification data for said one or more providers within said database;
(e) update said verification data to provide updated verification data within said database;
(f) store said facility data for one or more facilities within said database; and
(g) update said facility data to provide updated facility data within said database.

56. Computer executable code stored on a computer-readable medium, said code for managing a healthcare network, comprising:
(a) code for providing a relational database for provider data, verification data, and facility data;
(b) code for storing said provider data for one or more providers within said database;
(c) code for updating said provider data to provide updated provided data within said database;
(d) code for storing said verification data for said one or more providers within said database;
(e) code for updating said verification data to provide updated verification data within said database;
(f) code for storing said facility data for one or more facilities within said database; and
(g) code for updating said facility data to provide updated facility data within said database.
